(19) United States
(12) Patent Application Publication
(10) Pub. No.: US 2011/0125569 A1
(43) Pub. Date: May 26, 2011

(54) SYSTEMS AND METHODS FOR INTEGRATING ONLINE COMMERCE EXPERIENCES WITH SOCIAL MEDIA EXPERIENCES

(75) Inventors: Justin Yoshimura, Berkeley, CA (US); Hong Hu, (US)

(73) Assignee: 500Friends, Inc.

(21) Appl. No.: 12/952,055

(22) Filed: Nov. 22, 2010

Related U.S. Application Data
(60) Provisional application No. 61/263,316, filed on Nov. 20, 2009.

(51) Int. Cl. G06Q 30/00; G06Q 99/00

(52) U.S. Cl. 705/14.36; 705/26.1; 705/319

(57) ABSTRACT

Systems and methods are disclosed for integrating a user's purchase experience at an online merchant with a user's social media account and, separately, with a user group. When a user makes a purchase representation through a social media service about a merchant or a purchase choice to be made with the merchant, upon verification, the user is offered a merchant benefit. When a user can enlist a purchase group of users to each make a purchase from a merchant, upon meeting a group requirement, the purchase group is provided a group benefit.

### CROSS-REFERENCE TO RELATED APPLICATIONS

This application claims the benefit of U.S. Provisional Application No. 61/263,316 entitled “SYSTEMS AND METHODS FOR INTEGRATING ONLINE COMMERCE EXPERIENCES WITH SOCIAL MEDIA EXPERIENCES”, filed Nov. 20, 2009, and is hereby incorporated by reference in its entirety.

### TECHNICAL FIELD

The present disclosure generally relates to integration of online commerce with social media.

### BACKGROUND

Methods and systems for performing online commerce have experienced significant development as the Internet have matured and expanded. Therefore presently a great deal of commerce occurs online between buyers and sellers of various goods and services. Such commerce occurs through websites such as, for example, Amazon.com, Ebay.com, and Craigslist.org. Such a list is not exhaustive, and there can be no doubt that additional platforms for such commerce will be created. Types of such commerce include, for example, online retailers selling a high volume of products to online purchasers, online auctioneers mediating a large number of auctions online between auction participants, and online classifieds providers facilitating the existence of a significant secondary market in goods for resale between regular consumers.

Methods and systems for providing social media services to end users via the Internet have experienced a more recent surge of development. Therefore presently a tremendous volume of social interactions are facilitated by various sites on the World Wide Web including Facebook.com, LinkedIn.com, and MySpace.com. As is the case with online commerce, such a list of social media services is not exhaustive, and there can be no doubt that additional platforms for such social media services will be created. Types of such social media services include, for example, services for creating groups of friends, for communicating with groups of professional colleagues, for sharing media such as photos with a broad audience, etc.

### SUMMARY

Systems and methods are disclosed for integrating a user's purchase experience at an online merchant with a user's social media account and, separately, with a user group. When a user makes a purchase representation through a social media service, upon verification, the user is offered a merchant benefit. The user can select the social media service, and the purchase representation can be about the merchant or a purchase choice to be made with the merchant

When a user can enlist a purchase group of users to each make a purchase from a merchant, upon meeting a group requirement, the purchase group is provided a group benefit. The user can use a social media service to enlist the users of the purchase group. Alternatively or additionally, the user can use email to enlist other users to join the purchase group.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Examples of an electronic document comparison system and method are illustrated in the figures. The examples and figures are illustrative rather than limiting. The electronic document comparison system and method are limited only by the claims.

FIG. 1 shows an environment in which SocialBuy can be implemented.

FIG. 2 depicts a flow diagram illustrating an example process of implementing SocialBuy, according to one embodiment.

FIG. 3 shows an environment in which GroupBuy can be implemented.

FIG. 4 depicts a flow diagram illustrating an example process of implementing GroupBuy, according to one embodiment.

FIG. 5 depicts an example communication from a merchant to a user including a SocialBuy information.

FIG. 6 depicts an example communication from SocialBuy to a user including a selection of social media services to utilize.

FIG. 7 depicts an example communication from SocialBuy to a user including social media information regarding making a purchase representation using the social media.

FIG. 8 depicts an example communication from SocialBuy to a user including a SocialBuy information regarding merchant benefit or discount alternative.

FIG. 9 depicts an example communication from the social media including a purchase representation by a user.

FIG. 10 depicts a block diagram illustrating example functional modules of one embodiment of a processor or server used to run SocialBuy.

FIG. 11 depicts a block diagram illustrating example functional modules of one embodiment of a processor or server used to run GroupBuy.

### DETAILED DESCRIPTION

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

Efforts have been made in the past to bring together the worlds of online commerce and social media services. For example, social media services presently generate income for retailers in some circumstances where retailers present advertising on web pages viewable via social media services. The systems and methods disclosed herein integrate online commerce experiences with social media experiences, such as “SocialBuy” systems and methods and “GroupBuy” systems and methods. Briefly, a SocialBuy system can be utilized for integrating a user's purchase experience at an online merchant with a user's social media account by, for example, providing the user with a merchant benefit if the user makes a purchase representation about the online merchant or about the purchase. A GroupBuy system can be utilized for integrating a user's purchase experience at an online merchant with a user group by, for example, providing a group of users including the user with a merchant benefit if the group of users qualifies.

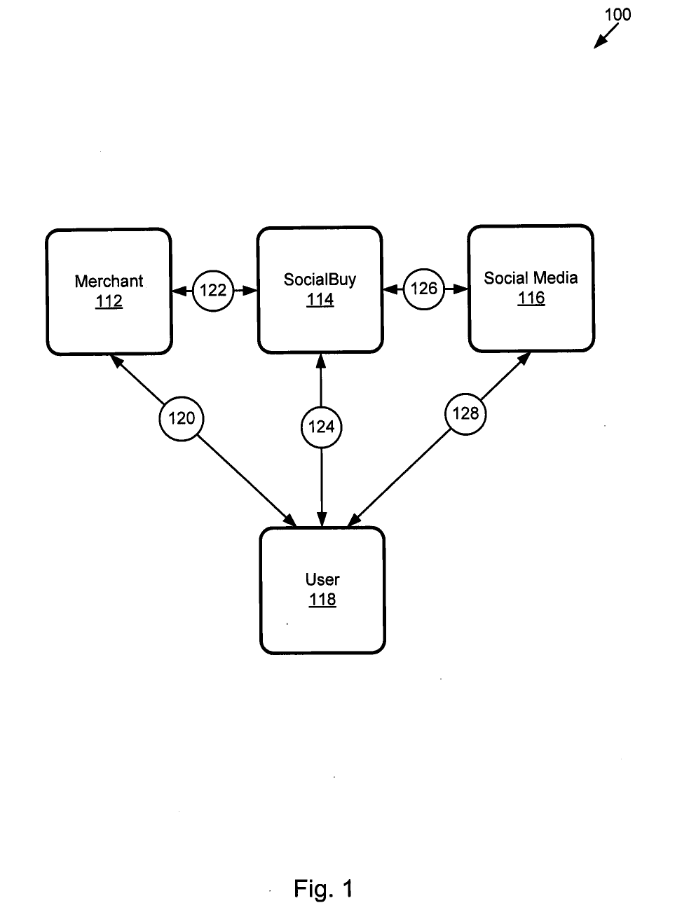

FIG. 1 depicts an example system 100 for implementing SocialBuy. System 100 includes user 118, merchant 112, SocialBuy 114, and social media 116. FIG. 1 also depicts transactions 120, 122, 124, 126, and 128. Each of transactions 120, 122, 124, 126, and 128 can be, for example, a communication or transmission mediated by a computer network, such as the internet, or other communication channel.

In various embodiments, user 118 can be implemented as various types of a user. For example, in one embodiment, user 118 is implemented as a computer, including a processor and a memory, that is configured to be connected to another computer over the Internet. For example, user 118 can be configured to connect to merchant 112, SocialBuy 114, and social media 116, which may be implemented themselves as computers as discussed further below. Importantly, user 118 in one embodiment includes account information (e.g., username and password information) for one or several of merchant 112, SocialBuy 114, and social media 116. User 118 can be configured for use by a person to log in to or otherwise access an account on one or several of merchant 112, SocialBuy 114, and social media 116. Generally, user 118 will be discussed herein as performing actions which may be undertaken by user 118 itself or by a person using user 118. User 118 is configured to participate in transactions 120, 124, and 128.

Merchant 112 can be implemented in one embodiment as a computer, including a processor and a memory, that is configured to be connected to another computer over the internet. Merchant 112 is an online merchant configured as, for example, an online retailer. In another embodiment, merchant 112 may be, for example, an online auctioneer, classifieds advertiser, or other online merchant. Merchant 112 provides goods, services, or both for sale to users such as user 118. Merchant 112 can further provide accounts to such users, for the purposes of purchase security, purchase authorization, and other retailing purposes. Merchant 112 is configured to participate in transactions 120 and 122.

Social media 116 can be implemented in one embodiment as a computer, including a processor and a memory, that is configured to be connected to another computer over the internet. Social media 116 is an online social media service provider. As such, Social media 116 is configured to provide one or more of a broad array of social media services. For example, social media 116 can provide services for creating, managing, communicating with, and sharing media or information with groups of friends, professional colleagues, or other groups of people or types of organizations. Social media 116 can further provide accounts to users such as user 118, for the purposes of identity security and other social media purposes. Social media 116 is configured to participate in transactions 126 and 128.

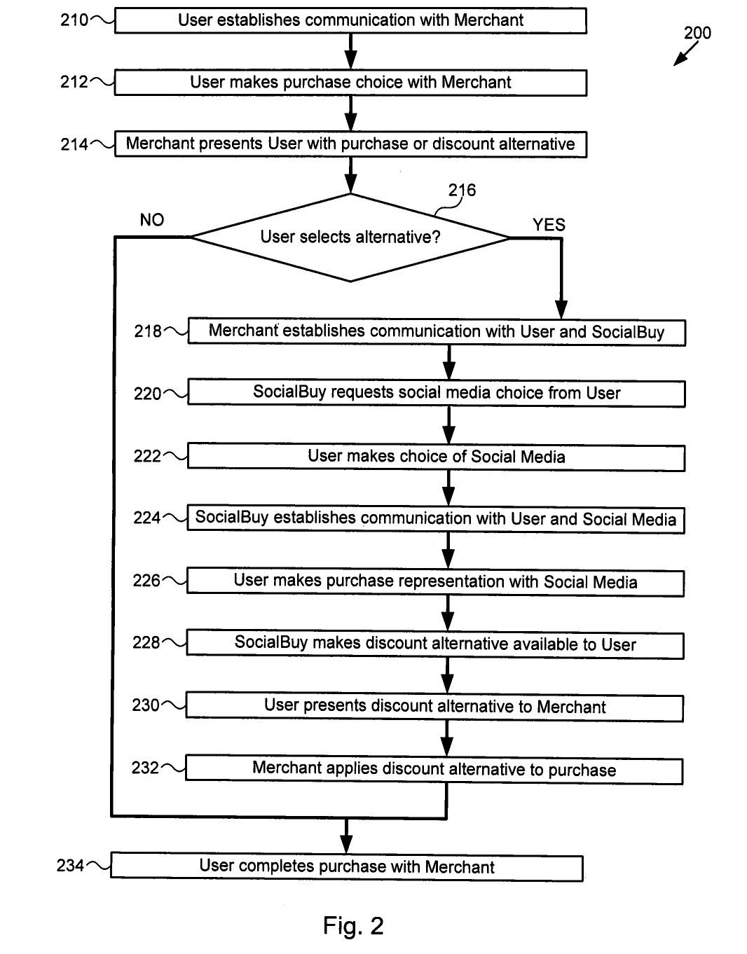

SocialBuy 114 can be implemented in one embodiment as a computer or server, including a processor and a memory, that is configured to be connected to another computer over the internet. SocialBuy 114 can integrate a purchase experience of user 118 at merchant 112 with an account of user 118 on social media 116 by, for example, providing user 118 with a merchant benefit if user 118 makes a purchase representation about merchant 112, or about a purchase, on social media 116. A merchant benefit can be, for example, a coupon, a discount, or other retail reward or retail incentive. A purchase representation can be, for example, a social media post on social media 116 about merchant 112 or about a purchase made or to be made by user 118 on merchant 112. A social media post can be, for example, a message created or authorized by a user (e.g., user 118) and made visible or accessible to another user on a social media service (e.g., social media 116). The social media post can be made visible or accessible to another user, or to a group of other users determined by, for example, a connection metric related to the posting user or another criteria. SocialBuy 114 is configured to participate in transactions 122, 124, and 126. In one embodiment, SocialBuy 114 can implement the method of flowchart 200 depicted in FIG. 2.

In some embodiments, the memory of SocialBuy 114 can store purchase choices and corresponding merchant benefits to be offered to users who make a purchase representation. In some embodiments, the memory of SocialBuy 114 can store information relating to the merchant benefits, for example, dates of expiration, different levels of benefits corresponding to different levels of purchase representation, and whether a user can apply for the merchant benefit multiple times.

FIG. 2 depicts flowchart 200 implementing SocialBuy. In one embodiment, Flowchart 200 can be implemented at least in part by SocialBuy 114 depicted in FIG. 1. Further, flowchart 200 can be implemented to include transactions 120, 122, 124, 126, and 128 depicted in FIG. 1.

In step 210 of flowchart 200, a user (e.g., user 118) establishes communication with a merchant (e.g., merchant 112). Step 210 can be included in transaction 120 depicted in FIG. 1. Step 210 can include, for example, the user transmitting account information to the merchant.

In step 212 of flowchart 200, the user makes a purchase choice with the merchant. Making a purchase choice can include, for example, selecting a product or service to purchase from the merchant. The purchase choice might further include, for example, selecting a shipping means and a payment means for the purchase.

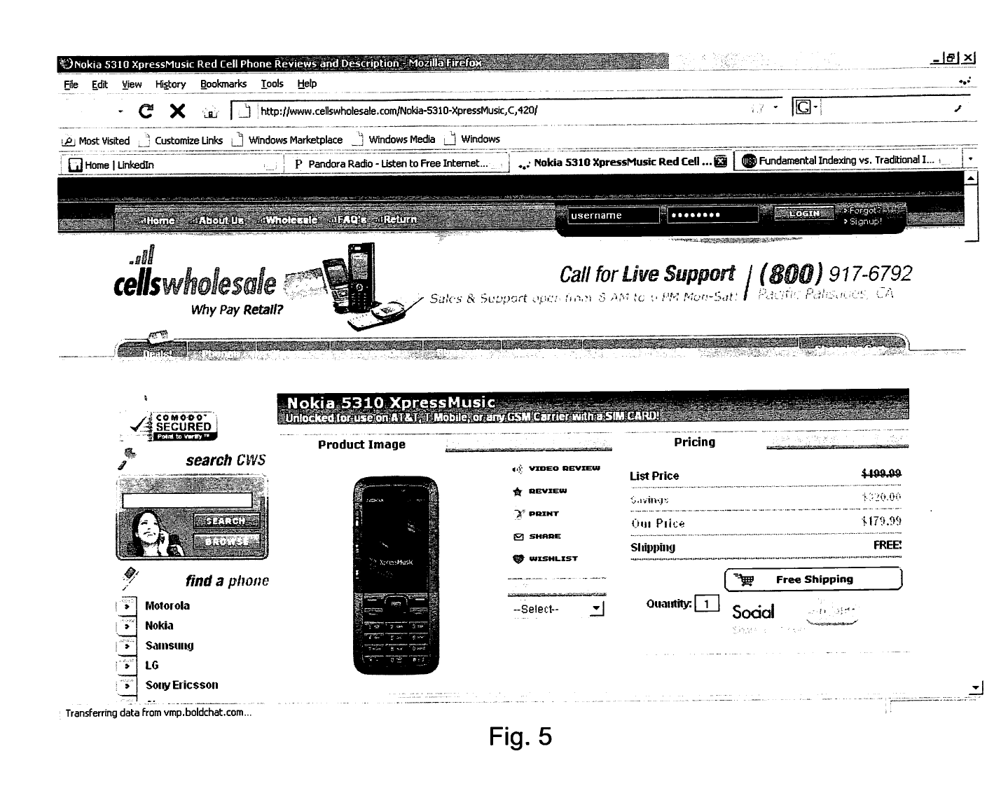

In step 214 of flowchart 200, the merchant presents the user with a purchase or discount alternative choice. FIG. 5 depicts an example communication from the merchant to a user including SocialBuy information where the user is offered $10 off the user's purchase for making a purchase representation.

At decision block 216, if the user chooses to purchase the selected product or service without making use of the alternative choice, then the user proceeds to step 234, where the user completes the purchase with the merchant. However, if the user instead chooses the discount alternative choice, then from decision block 216 the user proceeds to step 218.

In step 218 of flowchart 200, the merchant establishes communication with the user and with SocialBuy. This establishment may involve participating in one or more of transactions 120, 122, and 124 depicted in FIG. 1. For example, in one embodiment the merchant can act as a proxy through which the user accesses SocialBuy. In another embodiment, the merchant can instruct the user on establishing a direct connection to SocialBuy. In some embodiments, the merchant communicates with SocialBuy as to the purchase choice made by the merchant and an appropriate purchase or discount alternative for SocialBuy to make available to the user upon completion of a purchase representation.

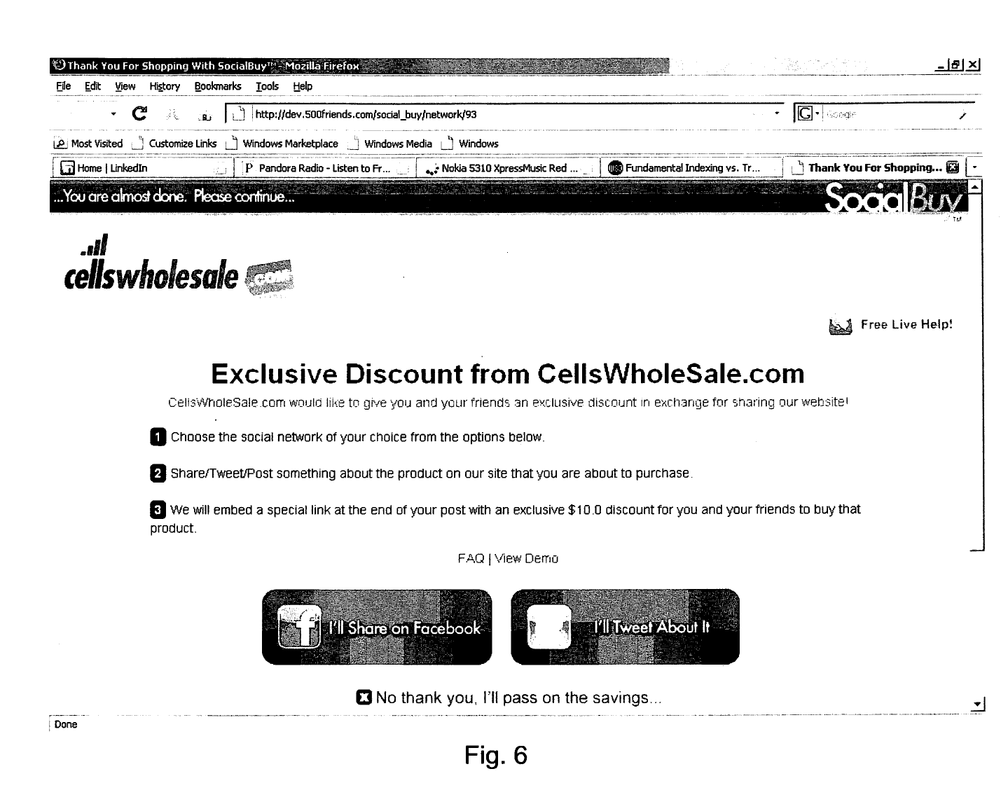

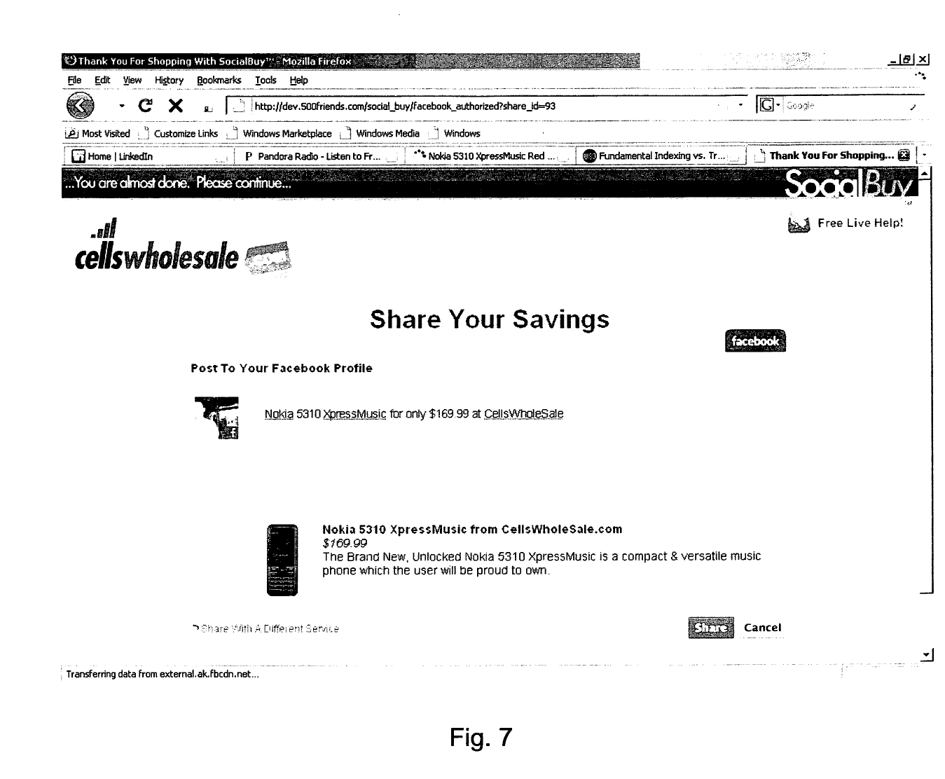

In step 220 of flowchart 200, SocialBuy requests a social media choice from the user. Notably, the request may be presented to the user directly from SocialBuy, or may be presented to the user via the merchant in various ways that do or do not disclose the participation of SocialBuy to the user. The request prompts the user to select one or more of several available social media services. FIG. 6 depicts an example communication from SocialBuy to a user including a selection of social media services to utilize, e.g. Facebook and Twitter. FIG. 7 depicts an example communication from SocialBuy to a user including social media information regarding making a purchase representation using the social media.

In step 222 of flowchart 200, the user makes a choice of social media. Making a choice of social media can involve the user viewing a set of available choices and selecting one for which the user presently has an account. Further, making the choice can involve prompting the user to set up an account on a social media service on which the user does not yet have an account. Still further, making the choice can involve prompting the user to type in or otherwise enter a social media service, and matching the entered request against a list of possible social media services.

In step 224 of flowchart 200, SocialBuy establishes communication with the user and the chosen social media. This establishment may involve participating in one or more of transactions 124, 126, and 128 depicted in FIG. 1. For example, in one embodiment SocialBuy can act as a proxy through which the user accesses the social media. In another embodiment, SocialBuy can instruct the user on establishing a direct connection to the social media.

In step 226 of flowchart 200, the user makes a purchase representation with the social media. The purchase representation can be, for example, a social media post on the social media about the merchant or about a purchase to be made by the user at the merchant. A social media post can be, for example, a message created or authorized by the user and made visible or accessible to another user on the social media. The social media post can be made visible or accessible to another user, or to a group of other users determined by, for example, a connection metric related to the posting user or another criteria. The purchase representation can be available or viewable to the merchant or to SocialBuy for validation or authorization purposes.

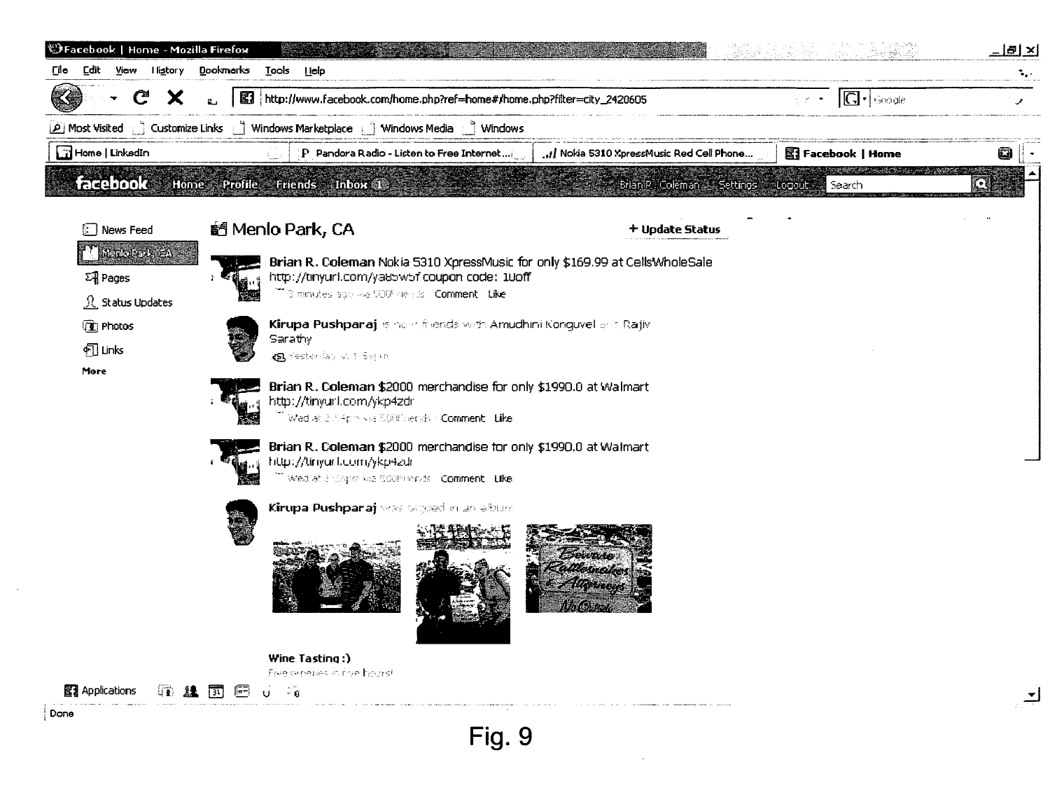

FIG. 7 depicts an example communication from SocialBuy to a user including social media information regarding making a purchase representation using the social media. FIG. 9 depicts an example communication from the social media including a purchase representation by a user.

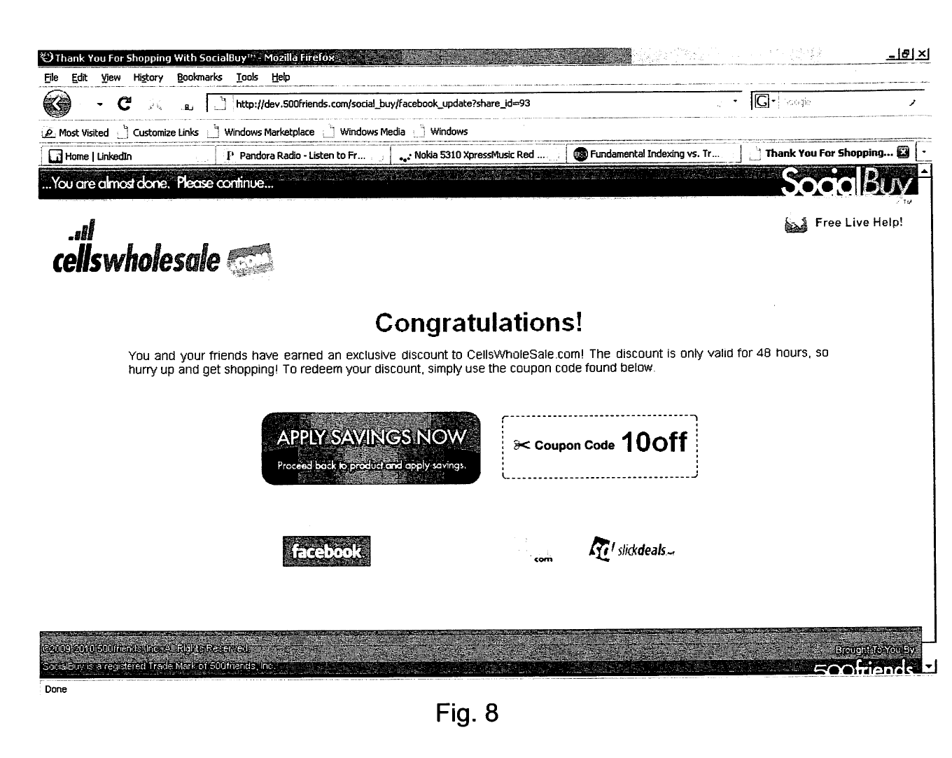

In step 228 of flowchart 200, SocialBuy makes the discount alternative available to the user. For example, SocialBuy can present the user with a merchant benefit, which is, for example, a coupon, a discount, or other retail reward or retail incentive. The merchant benefit will in one embodiment directly relate to the purchase choice made by the user in step 212. FIG. 8 depicts an example communication from SocialBuy to a user including a SocialBuy information regarding merchant benefit or discount alternative.

In step 230 of flowchart 200, the user presents the discount alternative to the merchant. Presenting the discount alternative may involve, for example, clicking a link viewable to the user, or may involve copying a code representative of the discount alternative for presentation to the merchant.

In step 232 of flowchart 200, the merchant applies the discount alternative to the purchase. In one embodiment, the purchase is the purchase choice made in step 212. Applying the discount alternative can include, for example, reducing a purchase price of the purchase by a discount percentage. After applying the discount alternative, in step 234 the user completes the purchase with the merchant.

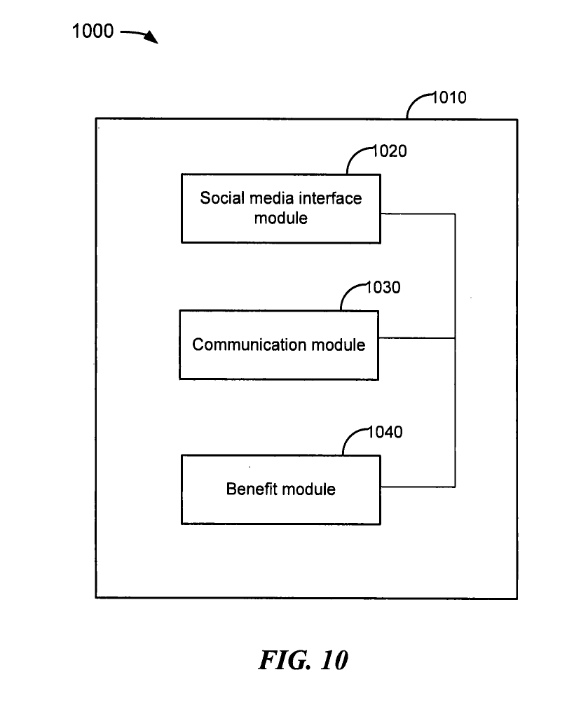

FIG. 10 depicts a block diagram 1000 illustrating example functional modules of one embodiment of a processor or server 1010 used to run SocialBuy. The comparison processor or server 1010 can include the following modules: a social media interface module 1020, a communication module 1030, and a benefit module 1040.

The social media interface module 1020 can be any combination of software agents and/or hardware components able to present one or more social media services to the user 118 and to request and receive a social media choice from the user 118 and to match the entered social media choice against a list of possible social media services. In some embodiments, the social media interface module 1020 can prompt the user to set up an account on a social media service on which the user does not yet have an account.

The communication module 1030 can be any combination of software agents and/or hardware components able to establish communication with the user and the chosen social media. In some embodiments, the communication module 1030 can act as a proxy through which the user accesses the selected social media service. In other embodiments, the communication module 1030 can instruct the user on how to establish a direct connection to the selected social media service. The communication module 1030 can further view a purchase representation made by the user 118 on the selected social media service to verify that the purchase representation has been made about the merchant from which the user wishes to purchase a good or service.

The benefit module 1040 can be any combination of software agents and/or hardware components able to interact with merchants to determine appropriate discount alternatives that should be offered to the user. In some embodiments, the benefit module 1040 can store, retrieve, and present one or more discount alternative choices or merchant benefits to the user.

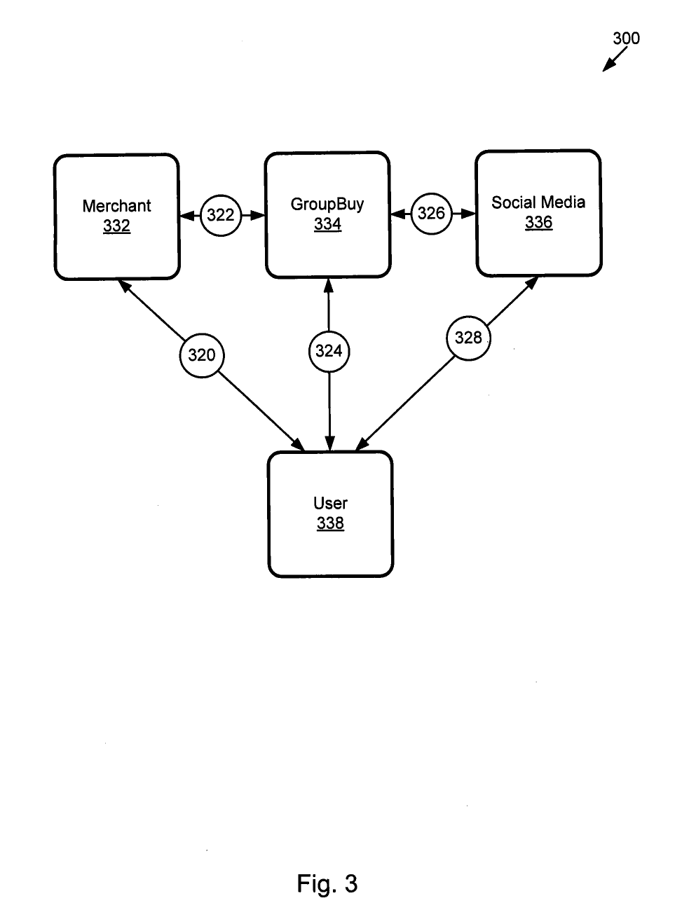

FIG. 3 depicts system 300 implementing GroupBuy. System 300 includes user 338, merchant 332, GroupBuy 334, and social media 336. FIG. 3 also depicts transactions 320, 322, 324, 326, and 328. Each of transactions 320, 322, 324, 326, and 328 can be, for example, a communication or transmission mediated by a computer network, such as the internet, or other communication channel.

In various embodiments, user 338 can be implemented as various types of a user. For example, in one embodiment, user 338 is implemented as a computer, including a processor and a memory, that is configured to be connected to another computer over the Internet. For example, user 338 can be configured to connect to merchant 332, GroupBuy 334, and social media 336, which may be implemented themselves as computers as discussed further below. Importantly, user 338 in one embodiment includes account information (e.g., username and password information) for one or several of merchant 332, GroupBuy 334, and social media 336. User 338 can be configured for use by a person to log in to or otherwise access an account on one or several of merchant 332, GroupBuy 334, and social media 336. Generally, user 338 will be discussed herein as performing actions which may be undertaken by user 338 itself or by a person using user 338. User 338 is configured to participate in transactions 320, 324, and 328.

Merchant 332 can be implemented in one embodiment as a computer, including a processor and a memory, that is configured to be connected to another computer over the internet. Merchant 332 is an online merchant configured as, for example, an online retailer. In other embodiment, merchant 332 may be, for example, an online auctioneer, classifieds advertiser, or other online merchant. Merchant 332 provides goods, services, or both for sale to users such as user 338. Merchant 332 can further provide accounts to such users, for the purposes of purchase security, purchase authorization, and other retailing purposes. Merchant 332 is configured to participate in transactions 320 and 322.

Social media 336 can be implemented in one embodiment as a computer, including a processor and a memory, that is configured to be connected to another computer over the internet. Social media 336 is an online social media service provider. As such, Social media 336 is configured to provide one or more of a broad array of social media services. For example, social media 336 can provide services for creating, managing, communicating with, and sharing media or information with groups of friends, professional colleagues, or other kinds of people or organizations. Social media 336 can further provide accounts to users such as user 338, for the purposes of identity security and other social media purposes. Social media 336 is configured to participate in transactions 326 and 328.

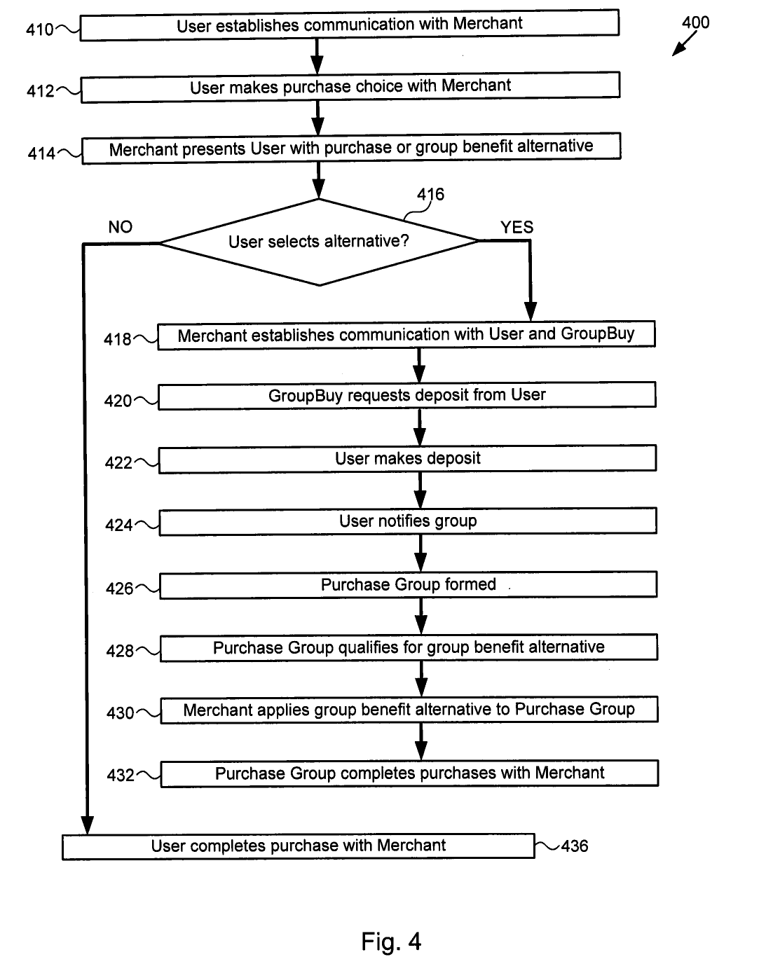

GroupBuy 334 can be implemented in one embodiment as a computer, including a processor and a memory, that is configured to be connected to another computer over the internet. GroupBuy 334 can integrate a purchase experience of user 338 at merchant 332 with an account of user 338 on social media 336 by, for example, providing a group of users (possibly including user 338) with a merchant benefit if the group of users qualifies. A merchant benefit can be, for example, a coupon, a discount, or other retail reward or retail incentive. Qualification of a group of users can include verification that the entire group has made purchase representations (e.g., social media posts on social media 336) about merchant 332 or about a purchase made or to be made by the group of users on merchant 332. Qualification can also include verifying that the group of users has reached a required size, or has reached a required group topology, or has existed for a certain amount of time, or has some other group characteristic that can be verified. In one embodiment, GroupBuy 334 maintains state information and other information about the group of users. Further, GroupBuy 334 can also be configured to perform the qualification of the group. GroupBuy 334 is configured to participate in transactions 322, 324, and 326. In one embodiment, GroupBuy 334 can implement the method of flowchart 400 depicted in FIG. 4.

FIG. 4 depicts flowchart 400 implementing GroupBuy. In one embodiment, Flowchart 400 can be implemented at least in part by GroupBuy 334 depicted in FIG. 3. Further, flowchart 400 can be implemented to include transactions 320, 322, 324, 326, and 328 depicted in FIG. 3.

In step 410 of flowchart 400, a user (e.g., user 338) establishes communication with a merchant (e.g., merchant 332). Step 410 can be included in transaction 320 depicted in FIG. 3. Step 410 can include, for example, the user transmitting account information to the merchant.

In step 412 of flowchart 400, the user makes a purchase choice with the merchant. Making a purchase choice can include, for example, selecting a product or service to purchase from the merchant. The purchase choice might further include, for example, selecting a shipping means and a payment means for the purchase.

In step 414 of flowchart 400, the merchant presents the user with a purchase or group benefit alternative choice. The group benefit alternative can involve setting up a purchase group for a bulk order of the type of product or service selected in step 412. For example, if the user selected one product item in step 412, the group purchase alternative can be a choice to purchase ten of the same product items by a purchase group of ten total users at a reduced per item price. If the user chooses to purchase, then from step 416 the user proceeds to step 436, where the user completes the purchase with the merchant. However, if the user instead chooses the group benefit alternative choice, then from step 416 the user proceeds to step 418.

In step 418 of flowchart 400, the merchant establishes communication with the user and with GroupBuy. This establishment may involve participating in one or more of transactions 320, 322, and 324 depicted in FIG. 3. For example, in one embodiment the merchant can act as a proxy through which the user accesses GroupBuy. In another embodiment, the merchant can instruct the user on establishing a direct connection to GroupBuy.

In step 420 of flowchart 400, GroupBuy requests a deposit from the user. The deposit is used to ensure that the user intends to set up a purchase group and meet the group requirements to qualify for the group benefit. Notably, the request may be presented to the user directly from GroupBuy, or may be presented to the user via the merchant in various ways that do or do not disclose the participation of GroupBuy to the user.

In step 422 of flowchart 400, the user makes a deposit. The deposit may be a fixed or flat deposit or may be, for example, a percentage of a purchase price. In some embodiments, the deposit is sent to the merchant to be applied towards the user's purchase choice. In some embodiments, the deposit is made to GroupBuy until the user's group has been verified, at which time the deposit can be either returned to the user or sent to the merchant.

In step 424 of flowchart 400, the user notifies at least one additional user about the group benefit. This notification may involve participating in one or more of transactions 324, 326, and 328 depicted in FIG. 3. For example, in one embodiment GroupBuy can act as a proxy through which the user accesses the social media to notify another user. In another embodiment, GroupBuy can instruct the user on establishing a direct connection to the social media. In a further embodiment, the user notifies another user without using the social media. For example, the user can email another user with instructions on connecting to GroupBuy to join the group.

In step 426 of flowchart 400, the purchase group is formed when another user joins the group. Notably, if another user joins the group, in one embodiment that new users is also asked to make a deposit. The deposit may be nonrefundable if the user cancels his participation in the purchase group.

In step 428 of flowchart 400, the purchase group qualifies for the group benefit alternative. Qualification of a purchase group can include verification that the entire group has made purchase representations about the merchant or about a purchase to be made by the purchase group. Qualification can also include verifying that the purchase group has reached a required size, or has reached a required group topology, or has existed for a certain amount of time, or has some other group characteristic that can be verified. Notably, a purchase group can fail to qualify if, for example, a time limit has expired. In such case, one or more users who have made a deposit can be refunded those deposits.

In step 430 of flowchart 400, the merchant applies the group benefit alternative to the purchase. In one embodiment, the purchase is the purchase choice made in step 412. Applying the group benefit alternative can include, for example, reducing a purchase price of the purchase by a discount percentage, or can include authorizing release of the group purchase to the members of the purchase group. After applying the group benefit alternative, in step 432 the purchase group completes the purchase with the merchant.

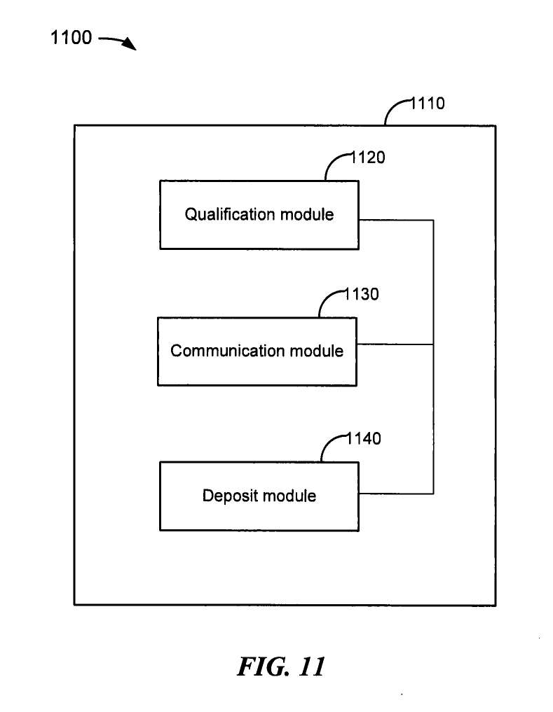

FIG. 11 depicts a block diagram 1100 illustrating example functional modules of one embodiment of a processor or server 1110 used to run SocialBuy. The comparison processor or server 1110 can include the following modules: a qualification module 1120, a communication module 1130, and a deposit module 1140.

The qualification module 1120 can be any combination of software agents and/or hardware components able to qualify a group of users by verifying that the entire group of users has made purchase representations, reached a required size, reached a required group topology, has existed for a certain amount of time, or some other group characteristic that can be verified. In one embodiment, the qualification module 1120 maintains state information and other information about the group of users.

The communication module 1130 can be any combination of software agents and/or hardware components able to establish communication with the merchant, the user and social media. In some embodiments, the communication module 1130 can act as a proxy through which the user accesses the social media to notify another user. In other embodiments, the communication module 1030 can instruct the user on how to establish a direct connection to the selected social media service.

The deposit module 1140 can be any combination of software agents and/or hardware components able to request a deposit from a user, track deposits from users, and to determine if the appropriate deposit amount has been made.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while text documents are mentioned, any type of electronic document may be processed under the principles disclosed herein. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

What is claimed is:

1. A system for integrating online commerce with social media interactions, comprising:
a communication module operable to communicate with a user and a merchant to determine the user's purchase choice and a merchant benefit if the user makes a purchase representation using a social media service;
a social media interface module operable to request and receive a social media service choice from the user, wherein the communication module is further operable to communicate with the chosen social media service to verify that the user has made the purchase representation;
a benefit module operable to present the user with the merchant benefit upon verifying that the user has made the purchase representation.

2. The system of claim 1, wherein the social media interface module further provides a list of social media services to the user from which to choose.

3. The system of claim 1, wherein the social media interface module prompts the user to set up an account on the chosen social media service if the user does hot have the account.

4. The system of claim 1, wherein the purchase representation is a post made on the social media service, and the post is visible to at least one other user of the social media service.

5. The system of claim 4, wherein the social media interface module provides a message to the user to be used as the post.

6. The system of claim 1, wherein the merchant benefit is selected from a group consisting of: a coupon, a discount, a purchase reward, and a purchase incentive.

7. The system of claim 1, wherein the purchase representation is about the merchant or the purchase choice to be made by the user.

8. The system of claim 1, wherein requesting and receiving a social media service choice from the user comprises directly requesting and receiving the social media service choice from the user, and the user is aware that the social media interface module is not part of the merchant.

10. The system of claim 1, wherein requesting and receiving a social media service choice from the user comprises requesting and receiving the social media service choice from the user through the merchant, and the user is not aware of the participation of the social media interface module.

11. The system of claim 1, further comprising:
a deposit module operable to request a deposit from each user in the purchase group of users;
a qualification module operable to verify that a purchase group of users including the user has met a group requirement, wherein the communication module is further operable to communicate with the user and the merchant to determine a group benefit if the purchase group of users meets the group requirement.

12. A system for integrating a user's purchase experience at an online merchant with a group of users, comprising:
a communication module operable to communicate with a user and a merchant to determine the user's purchase choice, a group requirement for qualifying a purchase group of users, and a group benefit if the user can qualify the purchase group of users;
a deposit module operable to request a deposit from the user;
a qualification module operable to verify the purchase group of users has met the group requirement.

13. The system of claim 12, wherein requesting the deposit comprises requesting the deposit through the merchant, and the user is not aware of the participation of the deposit module.

14. The system of claim 12, wherein the deposit module is further operable to request a deposit from each user in the purchase group of users.

15. The system of claim 14, wherein the deposit is nonrefundable to a first user in the purchase group if the first user cancels participation in the purchase group.

16. The system of claim 12, wherein the group requirement includes at least one of the following: each user in the purchase group has made a purchase representation about the merchant or a purchase to be made by the purchase group on a social media service, the purchase group has a minimum number of users, the purchase group has reached a group topology, the purchase group has existed for a minimum amount of time, or the purchase group has a verifiable group characteristic.

17. The system of claim 12, wherein verifying the purchase group of users has met a group requirement comprises maintaining state information and other information about each user in the purchase group.

18. A system,
at least one memory component storing a software program;
a processor coupled to the at least one memory component, wherein the processor is configured to execute the software program, the software program comprising:
a communication module operable to communicate with a user and a merchant to determine the user's purchase choice and a merchant benefit if the user makes a purchase representation about the merchant or the purchase choice using a social media service;
a social media interface module operable to request and receive a social media service choice from the user, wherein the communication module is further operable to communicate with the chosen social media service to verify that the user has made the purchase representation;
a benefit module operable to present the user with the merchant benefit upon verifying that the user made the purchase representation;
a deposit module operable to request a deposit from the user;
a qualification module operable to verify a purchase group of users has met a group requirement, wherein the communication module is further operable to communicate with the user and the merchant to determine a group requirement for qualifying a purchase group of users, and a group benefit if the user can qualify the purchase group of user.

19. A method of integrating online commerce with social media interactions, comprising:
communicating with a user and a merchant to determine the user's purchase choice and a merchant benefit if the user makes a purchase representation about the merchant or the purchase choice using a social media service;
requesting and receiving a social media service choice from the user, wherein the communication module is further operable to communicate with the chosen social media service to verify that the user has made the purchase representation;
presenting the user with the merchant benefit upon verifying that the user has made the purchase representation.

20. The method of claim 19, wherein the merchant applies the merchant benefit to the user's purchase choice.

21. The method of claim 19, wherein the purchase representation is a message created or authorized by the user and made visible or accessible to another user on the chosen social media service.

22. The method of claim 19, further comprising providing a list of social media services to the user from which to choose.

23. A method of integrating a user's purchase experience at an online merchant with a group of users, comprising:
communicating with a user and a merchant to determine the user's purchase choice, a group requirement for qualifying a purchase group of users and a group benefit for each member of the purchase group if the user can qualify the purchase group;
requesting a deposit from the user;
verifying the purchase group of users has met the group requirement.

24. The method of claim 23, further comprising requesting deposits from each user in the purchase group.

25. The method of claim 23, wherein verifying the purchase group of users has met the group requirement comprises maintaining state information and other information on each user of the purchase group.
